(19) United States
(12) Patent Application Publication
(10) Pub. No.: US 2010/0067753 A1
(43) Pub. Date: Mar. 18, 2010

(54) METHOD AND DEVICE FOR IMAGING A BLOOD VESSEL

(75) Inventor: Cornelis Pieter Visser, Den Bosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,935

(22) PCT Filed: Jun. 20, 2006
(86) PCT No.: PCT/IB2006/051987

§ 371 Date: Dec. 18, 2007

(30) Foreign Application Priority Data
Jun. 21, 2005 (EP) 05105496.3

(51) Int. Cl. G06K 9/46

(52) U.S. Cl. 382/128; 382/195

(57) ABSTRACT

A method for imaging a blood vessel (2) comprises the steps of: providing a two-dimensional view of the vessel; calculating a region of interest (40); defining a characterizing base path (13) of the vessel; within the region of interest (40), calculating a base line (22) perpendicular to the base path (13); along the base line (22), determining a transition where the base line intersects a side edge (2a, 2b) of the vessel; finding such transitions for many base lines; considering the collection of transitions as defining a side edge (27, 28) of the vessel; allowing a user to input an amendment command, and in response to receiving a user input amendment command, amending at least a portion of the region of interest and repeating the calculation with the amended region of interest.

### FIELD OF THE INVENTION

The present invention relates in general to a method for imaging a lengthy structure. The invention relates more specifically to a method for imaging a blood vessel in a body (human or animal), and the invention will be specifically explained in the context of blood vessels. However, it is noted that this example is not intended to restrict the scope of the present invention, since the gist of the present invention can also be applied to imaging other structures. In any case, a lengthy structure like a blood vessel can be characterized by a centerline following a path which may be straight or which may have curves, and a width which may be constant along the length of the centerline but which may also vary along the length of the centerline.

### BACKGROUND OF THE INVENTION

The imaging process typically involves the step of displaying a two-dimensional image derived from a three-dimensional volume. This two-dimensional image may be obtained by transmitting radiation, typically X-ray radiation, through the body in question. A radiation-sensitive receiver, typically a photographic plate, receives the radiation passing through the body, and, depending on absorption and transmission characteristics of structures within the body, a pattern results of darker and brighter shapes. Within this pattern, the blood vessel can be recognized. In order to enhance the contrast between the blood vessel and the surrounding tissue, a contrast agent is usually injected into the blood vessel. Nevertheless, it may sometimes be that it is difficult for the human eye to recognize exactly the side edges of the blood vessel. In order to assist a user, imaging apparatuses are capable of calculating the side edges of the blood vessel, and highlighting these side edges by drawing lines in the projected image. Apparatuses are also capable of for instance recognizing a stenosis, and calculating the size of the stenosis either in millimeters or as a percentage of the undisturbed vessel diameter, or both.

Methods for calculating the contour of a blood vessel are known in practice and in literature; by way of example, reference is made to U.S. Pat. No. 6,829,379. These methods generally operate as follows, as illustrated in FIGS. 1A-1F.

First, as illustrated in FIG. 1A, an image 1 is obtained of the blood vessel 2 and the neighboring structures 3, and this image 1 is shown on a screen of a computer system. The image 1 is typically obtained as a projection image using X-ray radiation, but it is also possible that the image 1 is obtained from a data set residing in a memory of the computer system.

A user is allowed to determine a segment of interest, typically by defining a first segment end point 11 and a second segment end point 12, each end point 11, 12 being located within the image of the vessel 2. For defining the end points of the segment, the computer system may have a mouse-type input device, allowing the user to displace a pointer over the screen and “click” at the desired locations. Since the concept of displacing a pointer icon over a computer screen and “clicking” at desired locations is commonly known, it is not necessary here to explain this concept in more detail.

Next, a characterizing base path 13 is calculated between the end points 11, 12, this base path following the shape of the vessel 2. This base path 13 can be calculated by the computer, using a minimum cost algorithm, but it is also possible that the base path is determined by the user, using the pointer icon as a drawing tool for drawing a straight or curved line inside the image of the vessel 2. It is noted that this base path is not necessarily equal to the centerline of the blood vessel, but typically the base path is a good approximation of the centerline.

As shown on a larger scale in FIG. 1B, a base point 21 is defined on the base line 13. For this base point 21, a base line 22 is calculated, intersecting the base point 21 and being directed perpendicular to the base path 13. The base line 22 has a limited length: end points of the base line 22 are indicated at 23 and 24.

FIG. 1B shows that the base line 22 intersects the side edges 2a and 2b of the vessel 2 in edge points 25 and 26, respectively. A computer program is capable of determining these edge points 25 and 26 by scanning the base line 22 and detecting a transition from a first brightness to a second brightness. In the case of a good contrast between the vessel and its surroundings, the edges 2a and 2b will correspond to a transition from dark to bright or vice versa.

The above steps are repeated for multiple base points along the length of the base path 13. Typically, these base points are located quite close to each other. As a result, a first set of edge points 25 is obtained, indicating the location of the first side edge 2a, and a second set of edge points 26 is obtained, indicating the location of the second side edge 2b. In each set of edge points, the neighboring edge points are connected by an edge line 27, 28 respectively, as illustrated in FIG. 1C. An edge line 27, 28 may either be defined as a succession of straight line pieces from edge point to edge point, but it may also be a smooth line. These two edge lines represent the calculated edges of the blood vessel, and show the contour of the blood vessel 2. A human observer may inspect the contour of the blood vessel, and may use this information for making a diagnosis. FIG. 1D illustrates an example where the blood vessel has a stenosis, i.e. a location where the flow path of the vessel is narrowed. Typically, the computer is capable of recognizing the stenosis, and calculating the flow diameter D2 at the location of the stenosis 31, either expressed as an absolute value in millimeters or as a ratio with respect to the undisturbed diameter D1 of the blood vessel. Since algorithms for recognizing and calculating stenosis are already known, while the present invention does not aim to provide improved algorithms for recognizing and calculating stenosis, it is not necessary to describe such algorithm here in detail.

In the step of determining edge points 25, 26 on the base line 22, a problem is encountered. Calculation of the edge points, i.e. the intersection of the base line with a side edge of the vessel, is performed on the bases of, inter alia, the contrast between darker and brighter image patterns. Depending on the location of the blood vessel within the body, and the direction of view, other parts of the body (e.g. bone) may interfere, so that the computer algorithm takes a wrong transition as the location for an edge point. This problem is illustrated in FIG. 1E, where the image 1 contains an image of some body part 5 close to the image of the vessel 2. The contrast between the vessel 2 and the disturbing body part 5 is relatively small, and it may be that this transition is ignored by the computer algorithm and that the computer algorithm takes the relatively large contrast between the disturbing body part 5 and the surroundings as indicating the side edge of the vessel. In such case, the computer algorithm will assume an erroneous side edge line 29, as illustrated in FIG. 1E. This erroneous representation of the blood vessel 2 may lead to erroneous diagnosis, such as for instance an erroneous location and/or size of a stenosis being calculated.

In the example of FIG. 1E, the error may be visually recognized by the skilled user, if the skilled user is observant and notices that the algorithm has taken the edge of the body part 5 in stead of the actual edge of the vessel 2. However, even if the error is recognized by the user, the state of the art does not provide the user with tools for correcting the error.

The present invention aims to overcome this problem.

### SUMMARY OF THE INVENTION

As mentioned, a base line 22 has end points 23, 24. The base line is only scanned for finding the edge points 25, 26 between said end points 23, 24. The end points of all base lines together define a region of interest, having a contour defined by the shape of the base path and by the length of the base lines. In the state of the art, all base lines have the same length, and this length is fixed. According to the invention, a tool is provided allowing the user to alter the region of interest. The user can visually analyze the vessel contour as calculated and presented on the screen, he can see where the contour seems to be correct and where the contour seems to be wrong, and he can alter the region of interest to force the computer algorithm to recalculate the contour.

According to the invention, the region of interest is also shown on the display screen. This may be done always, but this is preferably done only after receiving a corresponding user request. The user request may be given by pressing a key or a combination of keys, but it is also possible that, when the calculated contour of the vessel is presented on the display screen, the computer asks the user whether he is satisfied with the result; if the user response indicates that the user is not satisfied, the contour of the region of interest may be automatically shown.

### BRIEF DESCRIPTION OF THE DRAWINGS

These and other aspects, features and advantages of the present invention will be further explained by the following description with reference to the drawings, in which same reference numerals indicate same or similar parts, and in which:

FIGS. 1A-E schematically illustrate a process for finding side walls of a blood vessel in a 2D image;

FIG. 2 is a block diagram schematically illustrating an imaging system;

FIG. 3 illustrates schematically a region of interest being displayed on a display screen;

FIGS. 4A-B illustrate displacing the region of interest as a whole;

FIGS. 5A-B illustrate amending the shape of the base path of the region of interest;

FIGS. 6A-D illustrate amending the width of the region of interest;

FIGS. 7A-C illustrate amending the width of the region of interest in a proportional way;

FIG. 7D illustrates handle points being generated by the computer;

FIGS. 8A-E illustrate several variation of amending the width of a segment of the region of interest;

FIG. 9A illustrates amendment as an addition of a fixed length increment;

FIG. 9B illustrates amendment as a multiplication by a constant factor;

FIGS. 10A-C illustrate several variation of amending the width of the region of interest in 3D;

FIGS. 11A-B illustrate the effect of the invention in preventing calculation errors.

### DETAILED DESCRIPTION OF THE INVENTION

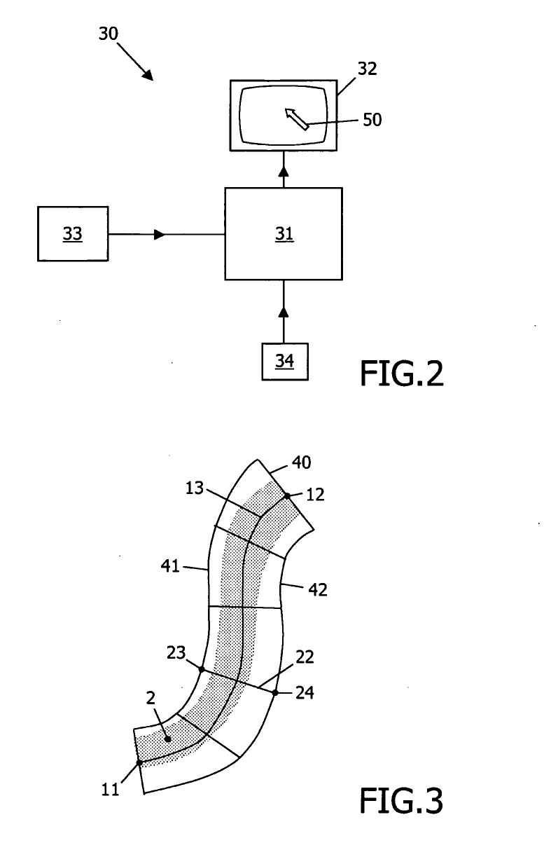

FIG. 2 is a block diagram schematically illustrating an imaging system 30 according to the present invention. The imaging system 30 comprises a control device 31, typically a suitably programmed computer, a display screen 32, a data source 33, and a user input device 34. The data source 33 may be a memory containing a data set, but may also involve an X-ray radiation apparatus or the like. The user input device 34 may involve a key board but preferably involves a mouse device. In a preferred embodiment, the imaging system 30 has a graphical user interface, involving a pointer 50 displayed on the screen 32, which can be displaced by user commands. Further, the user can input a selection command, selecting an object to which the pointer is pointing at that moment, for instance by clicking a mouse key. Further displacing the pointer will displace the selected object (dragging). Since the concept of clicking and dragging is commonly known, a further explanation is not necessary here.

FIG. 3 illustrates schematically a region of interest 40 being displayed on the display screen 32. FIG. 3 illustrates that the region of interest 40 is defined by the base path 13, the collection of base lines 22, and the end points 23, 24 of the base lines 22. The collection of all end points 23 located on one side of the base path 13 together define a first side edge 41 of the region of interest 40. Likewise, the collection of all end points 24 located at the opposite side of the base path 13 together define a second side edge 42 of the region of interest 40. By way of reference, the image of a vessel 2 is also indicated in FIG. 3.

The imaging system 30 is responsive to user input commands for altering the region of interest 40. The user input commands may be given via the graphical interface, as will be assumed in the following examples.

Several variations for the user amendments are possible.

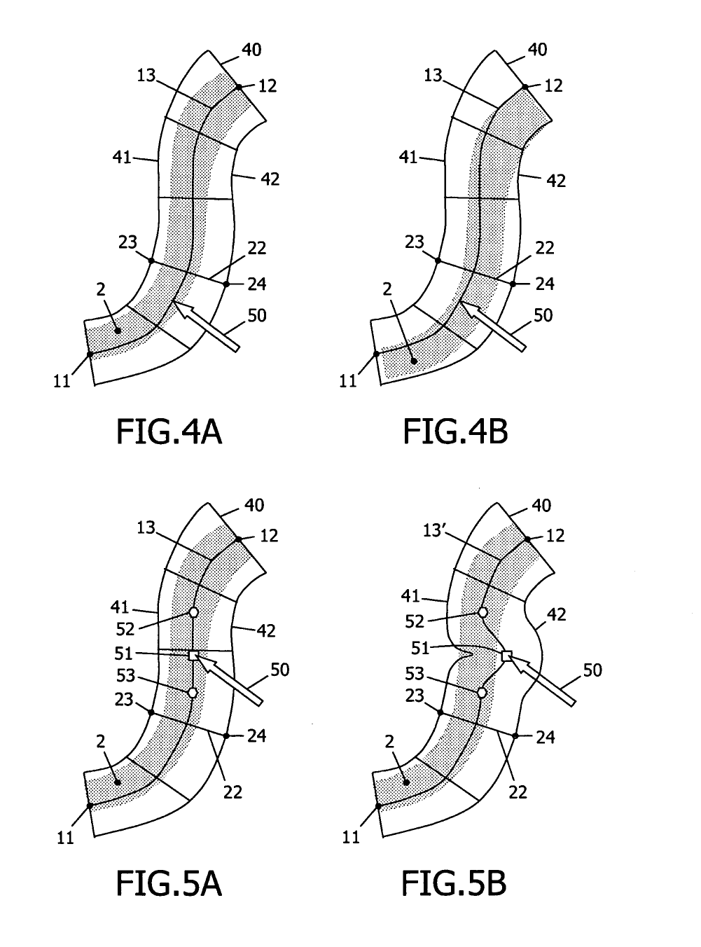

In one embodiment, it is possible to displace the region of interest 40 as a whole, including the base path 13. This is illustrated in FIGS. 4A and 4B. FIG. 4A illustrates the original region of interest 40, and a possible location where a pointer icon 50 can be positioned for picking up the region of interest 40: it is highly intuitive if such location is located on the base path 13. FIG. 4B shows the base path 13 with the region of interest 40 displaced with respect to the vessel image 2.

In a second embodiment, it is possible to amend the shape of the base path 13. This is illustrated in FIGS. 5A and 5B. FIG. 5A illustrates the original region of interest 40 with the original base path 13. By clicking on the base path 13, the user has placed two anchor icons 52, 53 and a handle icon 51 between the two anchor icons 52, 53. Using the pointer icon 50, the user can click and drag the handle icon 51. In response, the control device 31 calculates a new base path 13′. In the region outside the anchor icons 52, 53, the base path 13′ is equal to the original base path 13. In the region between the anchor icons 52, 53, the new base path 13′ is calculated as a smooth line through the anchor icons 52, 53 and the handle icon 51, connecting smoothly to the original base path 13 in the anchor icons 52, 53. FIG. 5B shows the new base path 13′ and the corresponding region of interest 40; the amendment to the base path is exaggerated.

In a third embodiment, it is possible to amend the width of the region of interest 40, maintaining the shape of the base path 13. Amending the width of the region of interest involves amending the lengths of base lines, the direction of the base lines perpendicular to the base path being maintained.

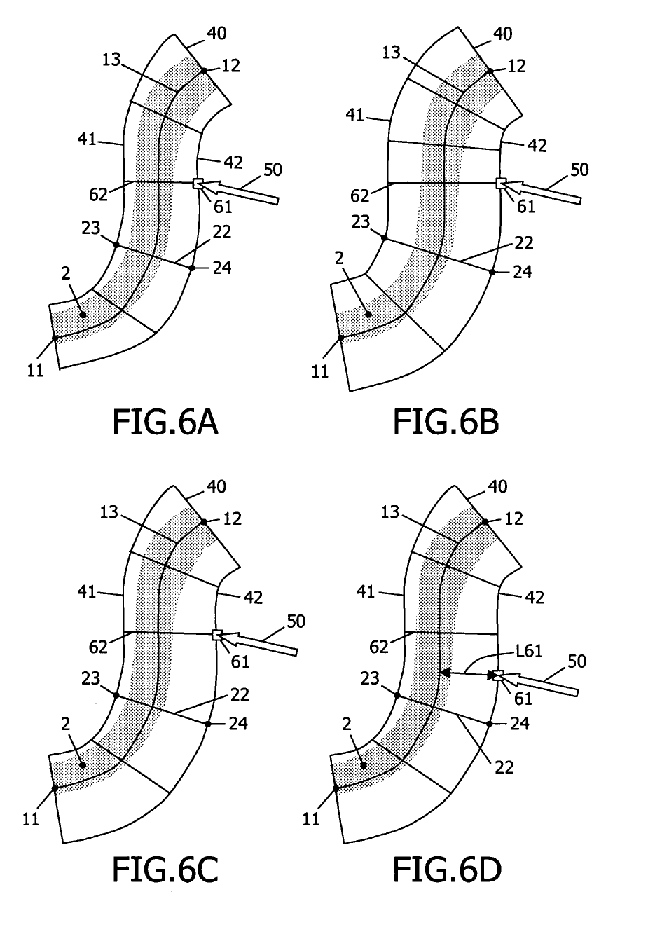

Normally, all base lines have the same length, and each base line is located symmetrically with respect to the base path 13, i.e. the midpoint of each base line 22 is located on the base path 13. In a first variation of the third embodiment, these features are maintained while increasing or decreasing the lengths of the base lines. User input may be done by pressing a suitable key, but it is also possible to use the mouse device. FIG. 6A illustrates the original region of interest 40 with the original base path 13. By clicking on a side edge 42 of the region of interest 40, the user has placed a handle icon 61 on this side edge 42. The corresponding base line through this handle icon 61 is indicated at 62. Using the pointer icon 50, the user can click and drag the handle icon 61 along this base line 62, thus displacing the end point of this base line 62. The control device 31 calculates the amended length L62 of the base line 62, and changes all base lines to have the same length L62, maintaining the locations of the midpoints to coincide with the base path. An example of the possible result is shown in FIG. 6B.

In a second variation of the third embodiment, it is possible that only the side edge 42 having the handle icon 61 is displaced while the other side edge 41 is maintained unamended. An example of the possible result is shown in FIG. 6C. The user action for effecting this second variation may be equal to the user action for effecting the first variation, with the exception of the need to additionally press a command button, for instance a control button or a shift button. It may be that the user action with the command button results in the first variation while the user action without the command button results in the second variation, or vice versa. It may also be that the user action with a first command button results in the first variation while the user action with a second command button results in the second variation, user action without a command key being ignored.

It is not essential that the handle icon 61 is displaced along the corresponding base line 62. Alternatively, it is possible that the handle icon is displaced to any desired location. In response, the control device 31 calculates a distance L61 from this location to the base path 13, and uses this distance for amending all base lines, either symmetrically (first variation) or only at one side of the base path (second variation). An example of the possible result is shown in FIG. 6D for the second variation.

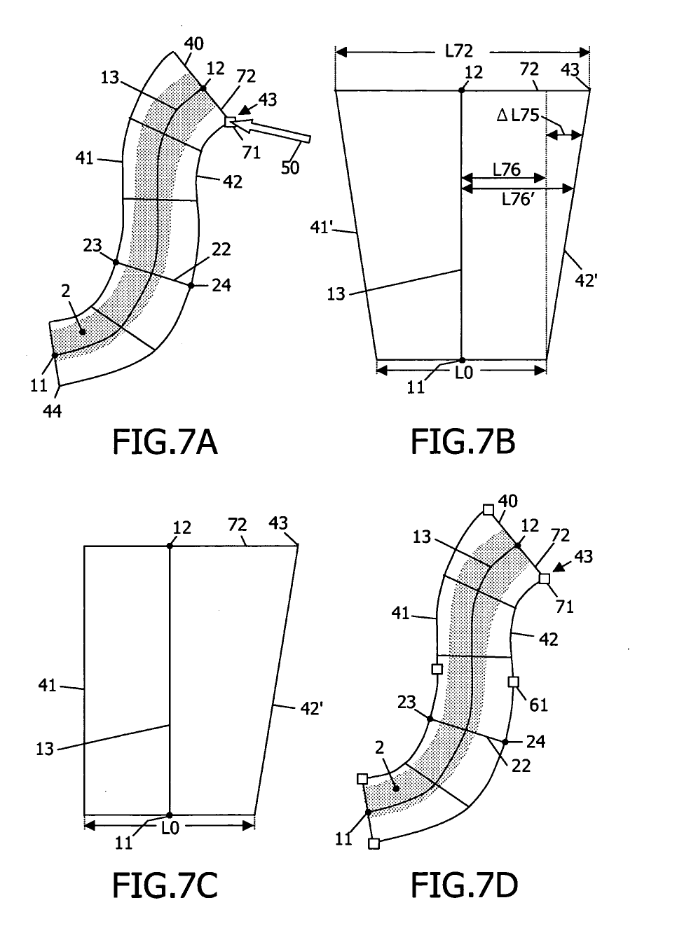

In a third variation, it is possible that the length of the base lines is not constant along the length of the base path but increases or decreases along the length of the base path. This is illustrated in FIGS. 7A-C. FIG. 7A illustrates the original region of interest 40 with the original base path 13. By clicking on a corner 43 of the region of interest 40, the user has placed a handle icon 71 on this corner 43. The corresponding base line through this handle icon 71 is indicated at 72, and corresponds to the end point 12 of the region of interest. Using the pointer icon 50, the user can click and drag the handle icon 71 along this base line 72, thus displacing the end point of this base line 72. The control device 31 calculates the amended length L72 of the base line 72, and changes the lengths of all base lines, such that the length of the base line (end edge) through the opposite end point 11 maintains its original length LO while the length of all intermediate base lines is changed in proportion to the distance of the corresponding base point to the said opposite end point 11, maintaining the locations of the midpoints to coincide with the base path. This is illustrated in FIG. 7B, where the base path 13 for the sake of simplicity is shown as a straight line so all base lines are assumed parallel.

In a fourth variation, it is possible that only the side edge 42 having the handle icon 71 is displaced while the other side edge 41 is maintained unamended. An example of the possible result is shown in FIG. 7C, which can be compared to FIG. 7B. The user action for effecting this fourth variation may be equal to the user action for effecting the third variation, with the exception of the need to additionally press a command button, for instance a control button or a shift button.

As indicated, it is possible that handle icons are placed by the user, by clicking at the desired location. Alternatively, as illustrated in FIG. 7D, it is also possible that the user gives a general amendment command, and that the control device 31 in response places handle icons 61, 71 on the side edges 41, 42 and/or in the corners of the region of interest 40. By clicking and dragging a selected one of these handle icons, the user can make the corresponding amendments as described above.

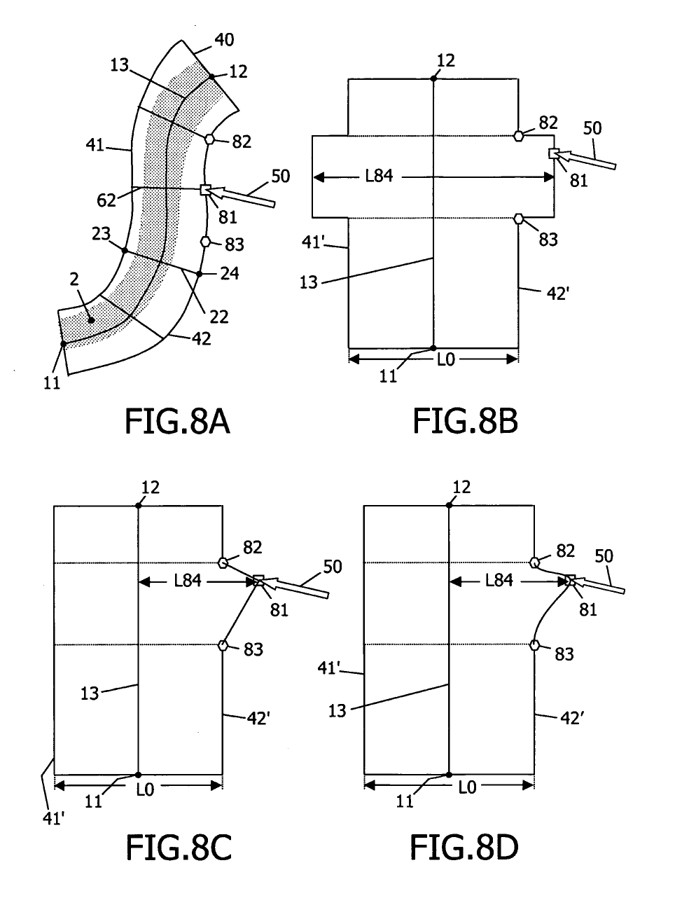

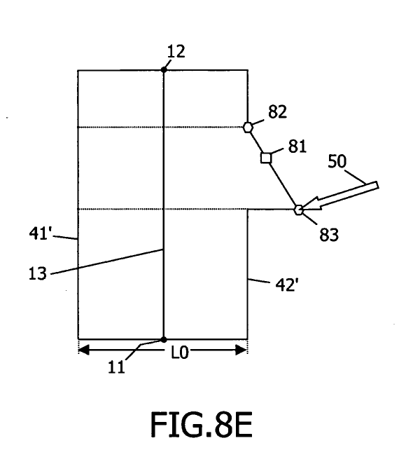

In the above variations, the length of the base lines is either maintained to be constant along the entire length of the base path or is amended to vary linearly from a minimum length L0 at one end point 12 to a maximum length L72 at the opposite end point 11. In a fifth variation, it is possible that the length of the base lines is given an extreme value (maximum/minimum) at a certain base point in between the two end points 11, 12. This is illustrated in FIGS. 8A-D. FIG. 8A illustrates the original region of interest 40 with the original base path 13. By clicking on the side edge 42, the user has placed two anchor icons 82, 83 and a handle icon 81 between the two anchor icons 82, 83. Using the pointer icon 50, the user can click and drag the handle icon 81, either along the corresponding base line 84 (see the first variation) or in an arbitrary direction. In response, the control device 31 calculates the amended length of the corresponding base line 84 or of a new base line 84′ defined by the new location of the handle icon 81. The control device 31 further calculates amended lengths for all base lines in the region in between the two anchor icons 82, 83, maintaining the lengths of all base lines outside this region.

The amended base lines in the region in between the two anchor icons 82, 83 may all obtain the same length, equal to the length L84 of the said corresponding base line 84 or 84′. An example of the possible result is shown in FIG. 8B. This figure also illustrates that the amended base lines may remain symmetrical with respect to the base path 13.

It is also possible that the amended base lines in the region in between the two anchor icons 82, 83 obtain a length which increases or decreases proportionally from the original length L0 at the anchor icons 82, 83 to the extreme value L84. An example of the possible result is shown in FIG. 8C. This figure also illustrates that it is possible that only the length of the half of the base lines located at one side of the base path 13 is amended, the other half of the base lines maintaining their lengths.

It is also possible that the amended base lines in the region in between the two anchor icons 82, 83 obtain a length which increases or decreases according to a curved line from the original length L0 at the anchor icons 82, 83 to the extreme value L84, such that the side edge 42 of the region of interest 40 has no sharp edges. An example of the possible result is shown in FIG. 8D.

In all of the above examples, the command for a single-sided amendment or a symmetrical amendment may be given by the user by pressing or not pressing a certain key.

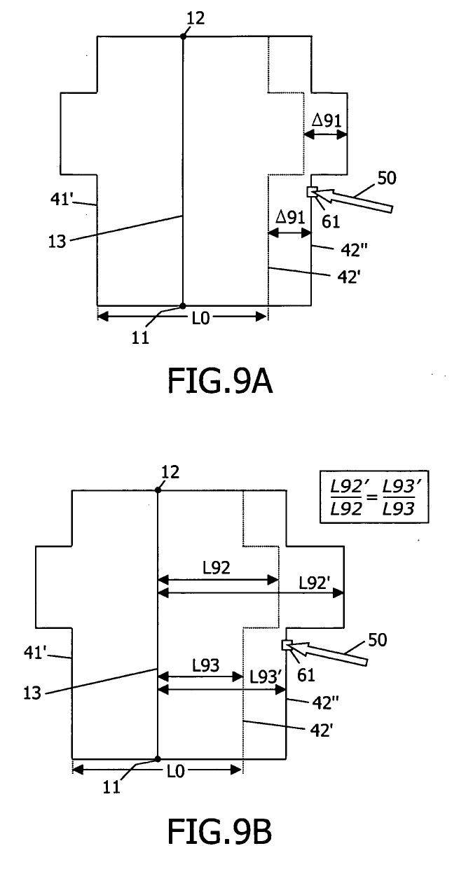

It is noted that the above examples take as starting point an original region of interest 40, where all base lines have the same length. However, it is also possible to perform two or more consecutive amendment steps: in such case, the starting point for the subsequent amendment step will be the result of the previous amendment step, in which case it may be that the starting situation has a certain asymmetry; for instance, the starting contour of the region of interest may be the contour shown in FIG. 8B. In the next amendment step, the amendments may be applied by adding an absolute value to the base line length or increasing the base lines with a certain percentage. An example of the possible result is shown in FIG. 9A. Using the handle icon 61 as described above with reference to FIG. 6C, the width of the region of interest as shown in FIG. 8B is increased one-sidedly by adding a fixed length increment Δ91 to all base lines (i.e. the difference [new length] minus [old length] is equal for all base lines). Alternatively, as shown in FIG. 9B, the width of the region of interest as shown in FIG. 8B is increased one-sidedly by increasing all base lines with the same percentage (i.e. the ratio [new length]/[old length] is equal for all base lines).

Likewise, the amendments illustrated in FIG. 7B can be obtained by adding an absolute length increment ΔL75, of which the size is proportional to the distance from end point 11 measured along the base path 13, or can be obtained by multiplying each base line length by a multiplication factor R76=L76′/L76, which multiplication factor is proportional to the distance from end point 11 measured along the base path 13.

With reference to FIGS. 7B and 7C, amendments have been described where the pointer 50 is used to pick a handle icon 71 placed at a corner 43 of the region of interest 40 to “pivot” the entire side edge 42 of the region of interest 40 around the opposite corner 44, the length of the side edge 42 increasing accordingly in order to maintain the length of the region of interest 40. Similarly, with reference to FIG. 8A, it is possible that the user uses the pointer 50 to pick an anchor icon 82 or 83. Displacing the selected anchor point 83 away from or towards the base path 13 will have a similar effect as displacing the corner icon 71, namely “pivoting” the portion of the side edge 42 located between the anchor icons 82 and 83 around the opposite anchor icon 82, as illustrated in FIG. 8E for a one-sided amendment.

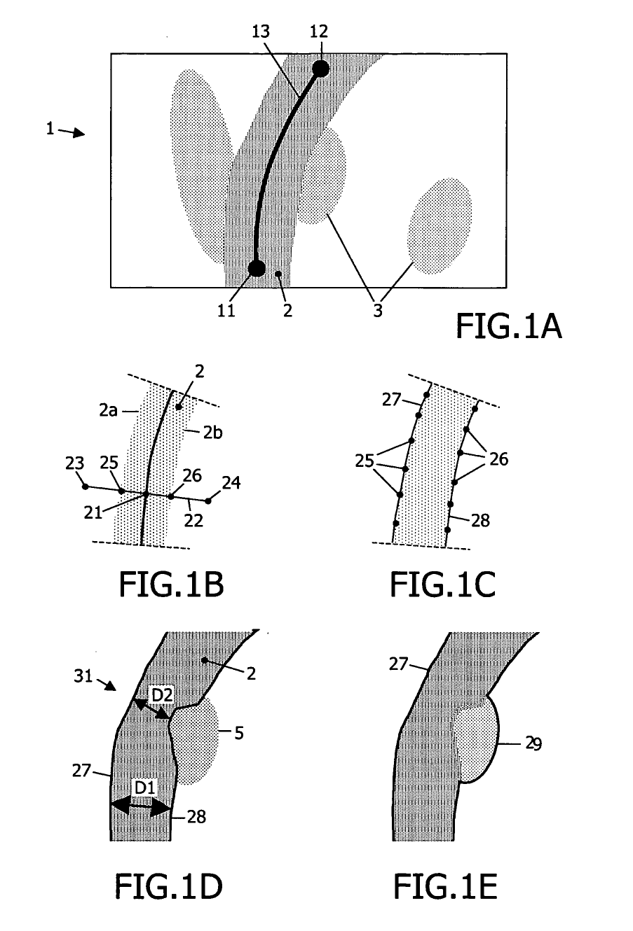

It is noted that the image 1 of FIG. 1A is a two-dimensional visualisation of a three-dimensional entity. This two-dimensional visualisation can be obtained in different ways.

First, it is possible to obtain the two-dimensional image as a projection image, for instance like an X-ray photo. Imaging radiation is caused to pass the body under observation from a source to a radiation sensitive surface. All body parts located between the source and the receiver contribute to the image, i.e. the image has “depth”.

Second, it is possible to obtain the two-dimensional image as a cross section, for instance like a CT scan. Only those body parts located in the cross section imaged contribute to the image, i.e. the image does not have “depth”.

Third, it is possible to calculate the image from a three-dimensional data set, which may have been obtained from, for instance, an MRI-scan. In such three-dimensional data set, the blood vessel of interest actually is a three-dimensional object, and the region of interest actually has a three-dimensional shape, resembling a curved cylinder (tube) around the base path. In such case, the calculations for finding the edges (contour) of the blood vessel within the region of interest may actually be performed in three dimensions, while the result is presented as a two-dimensional view, using a two-dimensional graphical display interface (display screen). Also, as described, the user commands may be given using two-dimensional graphical interface tools (pointer, handles; clicking, dragging). In such case, also the results of the user actions may be three-dimensional: even while the region of interest 40 is only displayed as a two-dimensional contour in the two-dimensional image 1, so that the amendments seem to only affect the region of interest 40 in the plane of the two-dimensional image 1, the region of interest 40 may actually be affected in three dimensions.

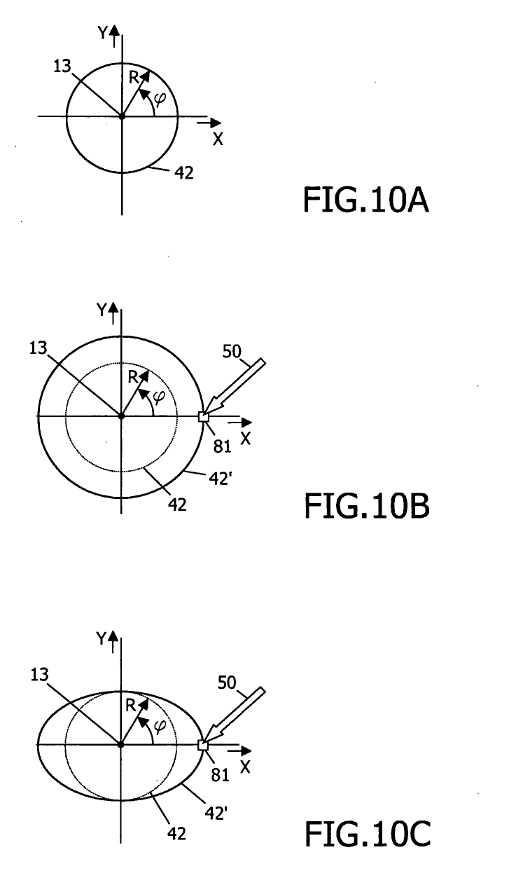

FIG. 10A shows a schematical cross section of the region of interest 40 according to a plane perpendicular to the base path 13; it is assumed that the contour of the region of interest 40 is circular in this section. Rectangular coordinate systems X, Y and R, φ are shown; a third coordinate Z is taken perpendicular to the plane of drawing, i.e. parallel to the base path 13. It is assumed that the image 1 in FIG. 1A is located in the XZ-plane, so that the direction of viewing the image 1 in FIG. 1A corresponds to the Y-direction. By way of example referring to FIG. 8A, a handle icon 81 is shown in FIG. 10A.

When the user uses the pointer 50 to displace the handle icon 81 away from the base path 13, all base lines corresponding to the same base point 21 may be enlarged by the same amount (either as en absolute value or as a percentage), independent from their φ-coordinate, as illustrated in FIG. 10B (see also FIG. 8B).

It is also possible that the increase is zero in the Y-direction, and is proportional to the φ-coordinate from X-direction to Y-direction, as illustrated in FIG. 10C. The increase may depend on the φ-coordinate linearly, or according to a sine curve, or any other suitable curve.

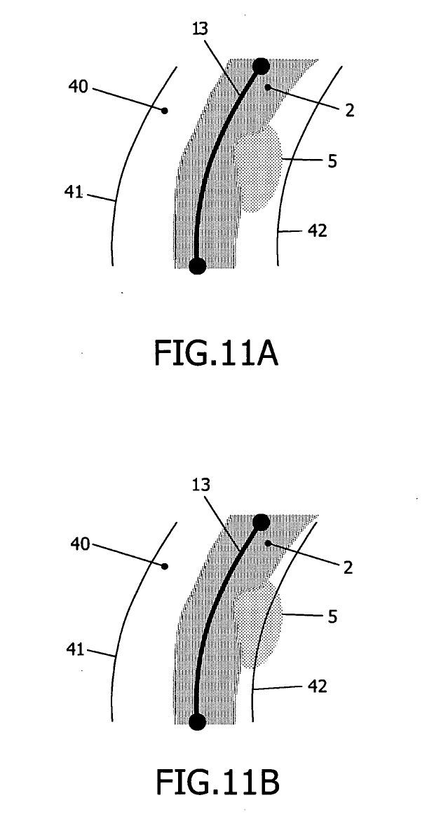

Thus, the present invention provides a highly intuitive, easy to use tool for amending the region of interest 40. As a result, the user can eliminate certain errors. This is explained with reference to FIGS. 11A-B. FIG. 11A schematically shows the vessel 2 and body part 5 of FIGS. 1D-E, and also shows a base path 13 and a relatively broad region of interest 40 with side edges 41, 42. Both the vessel 2 and the body part 5 are located within the region of interest 40. In that case it is possible that the algorithm provides the erroneous calculation result illustrated in FIG. 1E.

FIG. 11B shows the same image as FIG. 11A, the width of the region of interest 40 now being reduced single-sidedly. Although the righthand side edge 42 does not follow exactly the side edge of the vessel 2, and although the region of interest 40 still contains a portion of the body part 5, the algorithm can not take the transition from body part 5 to surroundings into account any more, so the algorithm is forced to use the transition from body part 5 to vessel 2, resulting in the correct calculation result illustrated in FIG. 1D.

Thus, the present invention succeeds in providing a method for imaging a blood vessel. The method comprises the steps of:
providing a two-dimensional view of the vessel;
defining a characterizing base path 13 of the vessel;
calculating a region of interest 40 as a strip aligned with the base path 13;
within the region of interest 40, calculating a base line 22 perpendicular to the base path 13;
along the base line 22, determining a transition where the base line intersects a side edge 2a, 2b of the vessel;
determining such transitions for many base lines;
considering the collection of transitions as defining a side edge 27, 28 of the vessel;
allowing a user to input an amendment command and, in response to receiving a user input amendment command, amending at least a portion of the region of interest and repeating the calculation with the amended region of interest.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for imaging a lengthy structure (2), the method comprising the steps of:
a) providing a two-dimensional view of the structure (2) and its surroundings;
b) defining a segment of the structure;
c) defining a characterizing base path (13) between end points (11, 12) of the structure segment;
d) defining a region of interest (40) as a strip aligned with the base path (13);
e) within the region of interest (40), calculating side edges (2a, 2b) of the structure segment;
f) projecting a representation (27, 28) of the calculated edges over the two-dimensional view of the structure;
wherein step (e) comprises the steps of:
e1) defining at least one base point (21) on the base path;
e2) calculating a base line (22) through the base point (21) perpendicular to the base path (13), the base line having a predetermined length and two mutually opposite end points (23, 24) corresponding to side edges (41, 42) of the region of interest (40);
e3) along the base line (22), on both sides of the base path (13), scanning the two-dimensional view and determining a transition indicating an intersection point (25, 26) where the base line intersects the side edge (2a, 2b) of the structure;
wherein step (f) comprises the step of defining a line (27, 28) connecting the intersection points (25, 26) obtained at multiple base points;
the method being characterized by the steps of:
g) projecting a representation of the region of interest (40) over the two-dimensional view of the structure;
h) receiving a user input amendment command for amending the region of interest;
i) in response to receiving the user input amendment command, amending at least a portion of the region of interest;
j) with the amended region of interest, repeating steps (e) and (f).

2. Method according to claim 1, wherein step (i) includes the step of displacing the region of interest as a whole.

3. Method according to claim 1, wherein step (i) includes the step of amending the shape of at least a portion of the region of interest (40).

4. Method according to claim 3, wherein step (i) includes the step of amending the shape of at least a portion of the base path (13).

5. Method according to claim 3, wherein step (i) includes the step of amending the width of at least a portion of the base path (13).

6. Method according to claim 5, wherein, within said portion of the base path (13), the lengths of the base lines (22) are amended and amended side edges (41′, 42′) of the amended region of interest (40) are calculated on the basis of the amended locations of the end points (23, 24) of the base lines (22).

7. Method according to claim 6, wherein length amendments are calculated as the addition of a certain increment/decrement (ΔL75; Δ91), or as a multiplication by a certain factor (L76′/L76; L92′/L92).

8. Method according to claim 7, wherein the length amendments for all base lines within the said portion of the region of interest are mutually equal.

9. Method according to claim 7, wherein the length amendments for all base lines within the said portion of the region of interest are symmetrical with respect to the base path.

10. Method according to claim 7, wherein the length amendments for all base lines within the said portion of the region of interest are continuously increasing or decreasing along the length of the base path.

11. Method according to claim 7, wherein the length amendments for all base lines within the said portion of the region of interest have an extreme value (maximum; minimum) at a location within said portion while the length amendments for the base lines at the ends of said portion are zero.

12. Method according to claim 1, wherein step (h) includes the step of receiving a graphical input command.

13. Method according to claim 12, wherein step (h) includes the steps of projecting at least one handle icon (51; 61; 71) on the region of interest, projecting at least one pointer icon (50), receiving user input commands for displacing the pointer icon, receiving user input commands (“click”) for visually attaching the pointer icon to the handle icon, and receiving user input commands (“drag”) for displacing the handle icon (51; 61; 71) together with the pointer icon (50).

14. Method according to claim 13, wherein the handle icon (51; 61; 71) is defined by a control device (31).

15. Method according to claim 13, wherein the handle icon (51; 61; 71) is placed by the user.

16. Method according to claim 13, further comprising the step of projecting two anchor points (82, 83) for defining the said portion of the region of interest, and projecting a handle icon (81) in between the anchor points (82, 83).

17. Method for calculating stenosis (31) in a blood vessel (2), comprising the steps of:
imaging the blood vessel (2) using the method of claim 1;
calculating an average diameter (D1) of the blood vessel (2) on the basis of the calculated side edges (27, 28);
determining a narrower portion (31) of the blood vessel (2) on the basis of the calculated side edges (27, 28);
calculating the diameter (D2) of the passage of the narrower portion (31) on the basis of the calculated side edges (27, 28);
providing an output signal indicating the diameter (D2) of the stenosis (31) or indicating the ratio (D2/D1) between the diameter (D2) of the stenosis (31) and the average diameter (D1) of the blood vessel (2).

18. Imaging apparatus (30), designed for performing the method according to claim 1.
